(19) United States
(12) Patent Application Publication
(10) Pub. No.: US 2009/0203480 A1
(43) Pub. Date: Aug. 13, 2009

(54) DEVICE FOR CONTROLLING A FLUID-ACTIVATED DOUBLE-ACTION OPERATING CYLINDER

(75) Inventors: Rainer Petzold, Friedrichshafen (DE); Bernd Müller, Friedrichshafen (DE); Werner Wolfgang, Ravensburg (DE); Thomas Jäger, Meckenbeuren (DE); Mario Steinborn, Friedrichshafen (DE); Ulrich Reith, Schlier (DE); Peter Herter, Ravensburg (DE); Roland Mair, Tettnang-Laimnau (DE)

Correspondence Address: DAVIS & BUJOLD, P.L.L.C., 112 PLEASANT STREET, CONCORD, NH, 03301, US

(73) Assignee: ZF Friedrichshafen AG, Friedrichshafen (DE)

(21) Appl. No.: 12/304,563

(22) PCT Filed: Jun. 6, 2007
(86) PCT No.: PCT/EP2007/055570

§ 371 Date: Dec. 12, 2008

(30) Foreign Application Priority Data
Jun. 29, 2006 (DE) 10 2006 030 034.3

(51) Int. Cl. F16H 31/00

(52) U.S. Cl. 475/127

(57) ABSTRACT

A device for controlling a fluid-actuated, double-action operating cylinder (2) having two cylinder chambers (6, 8) separated from one another by a piston (4). Each cylinder chamber (6, 8) communicates with a respective valve (12, 14) for controlling the flow of fluid in and out of the cylinder chamber (6, 8) and a pressure sensor (40) for detecting the fluid supply pressure. A control unit (20) is connected to the switching valves (12, 14) and the pressure sensor (40). To determine the actual control force of the operating cylinder (2), the pressure sensor (40) is arranged between the cylinder chambers (6, 8) and the control unit (20). The output from the pressure sensor (40) can be processed in the control unit (20) and used for actuating a pressure regulation valve (22) arranged in the pressure line (32).

This application is a national stage completion of PCT/EP2007/055570 filed Jun. 6, 2007, which claims priority from German Application Serial No. 10 2006 030 034.3 filed Jun. 29, 2006.

### FIELD OF THE INVENTION

The invention concerns a device for controlling a fluid-actuated, double-action operating cylinder.

### BACKGROUND OF THE INVENTION

Fluid-actuated, double-action operating cylinders are used as operating drives for automated transmissions or clutches in motor vehicles and can be part of a pneumatic or a hydraulic system. As is known, the piston of a double-action operating cylinder can move in two directions. In general, the fluid inflow or fluid outflow for the cylinder chambers of an operating cylinder or the blocking of the chambers to prevent inflow or outflow are controlled by switching valves connected to the control unit. In addition, a pressure sensor device is often provided upstream from the operating cylinder in a pressure medium liner which detects the fluid supply pressure and transmits it to a control unit so that conclusions can be reached from the actuating pressure about the actuation or switching force of the operating cylinder.

From DE 102 49 341 A1 a device is known in which a pressure sensor is provided upstream from the branching point to the two switching valves in a pressure fluid line connected to a pressure fluid source. This sensor detects the fluid pressure in the pressure fluid line and transmitting its value to a control unit. Due to dynamic effects, the compressibility of pressure fluids, the occurrence of dynamic pressures on the outlet side of the operating cylinder, etc., this device is inexact since only the pressure on the inlet side is detected, but not any pressure that may exist on the outlet side. A further drawback is considered to be that control and regulation processes in which defined pressures must be produced in both cylinder chambers of the operating cylinder, cannot be implemented by the known means.

DE 199 31 973 A 1 shows a device similar to the one disclosed in the above document. In this case too a pressure sensor is arranged upstream from a branching point where a pressure fluid line branches off toward two switching valves so that this device suffers from the same disadvantages described in connection with the document mentioned earlier.

Against this background the purpose of the present invention is to provide a device, such that in both static and dynamic operating conditions, the actual switching force of the operating cylinder can be measured so that the latter can be controlled, adapted and regulated in a high-quality manner.

### SUMMARY OF THE INVENTION

The invention is based on recognition of the fact that the switching force of an operating cylinder always depends both on the inflow pressure into one of the two cylinder chambers and on the outflow pressure in the other cylinder chamber.

Accordingly, the invention starts from a device for controlling a fluid-actuated, double-action operating cylinder with two cylinder chambers separated from one another by a control piston and, in each case, with a respective switching valve associated with each cylinder chamber to control the fluid inflow and the fluid outflow for the cylinder chambers and further with a pressure sensor device for detecting the fluid supply pressure and with a control unit connected to the switching valves and the pressure sensor device.

To achieve the stated objective it is provided that as the pressure sensor device, a differential pressure sensor is provided, which is arranged between the two cylinder chambers.

With a device of this type, the pressure difference between the two cylinder chambers can be determined and, if the geometry of the operating cylinder is known, then so too can be the actual actuation or switching force of the operating cylinder. This information then also enables accurate monitoring and, if necessary, accurate regulation of the switching force.

In the static condition, i.e., when the switching valve for one of the two cylinder chambers is open, then as with the known arrangements, the liquid supply pressure upstream from the operating cylinder can be determined directly.

Differential pressure sensors are inexpensive structural elements commonly available on the market, so that the arrangement as a whole is not costly.

According to a preferred embodiment of the invention, it is provided that a controllable pressure regulation device connected to the control unit is arranged upstream from the two switching valves, which obtains its control information from the differential pressure sensor also connected to the control unit.

In the case of a device, with a pressure fluid line connected to a source of pressurized fluid, which branches upstream from the switching valves into two switching valve supply lines, according to a further feature of the invention, it is provided that the pressure regulation device is a pressure regulation valve arranged upstream from the branching point and actuated by the control unit, such that the fluid supply pressure for the two switching valves and the cylinder chambers downstream from them can be regulated. Such pressure regulation valves are made as pulse-width-modulated, timed, electromagnetic switching values. In this way, the fluid supply pressure for the two cylinder chambers can be controlled, adapted or regulated exactly as a function of the information signal from the differential pressure sensor.

In cases when control and regulation methods should be used in which defined pressures have to be produced in both cylinder chambers, according to another feature of the invention, it is provided that the pressure regulation system comprises a respective pressure regulation valve actuated by the control unit in each of the supply lines, i.e., after the branching point and the control information for actuating these two pressure regulation valves again comes from the differential pressure sensor.

### BRIEF DESCRIPTION OF THE DRAWINGS

The invention will now be described, by way of example, with reference to the accompanying drawings in which:

FIG. 1 is a schematic representation of a device with a differential pressure sensor and a pressure regulation valve arranged in the pressurized fluid line upstream from a branching point, and

FIG. 2 is a device somewhat like that of FIG. 1, but with two pressure regulation valves, each arranged in the pressurized fluid line after a branching point.

### DETAILED DESCRIPTION OF THE INVENTION

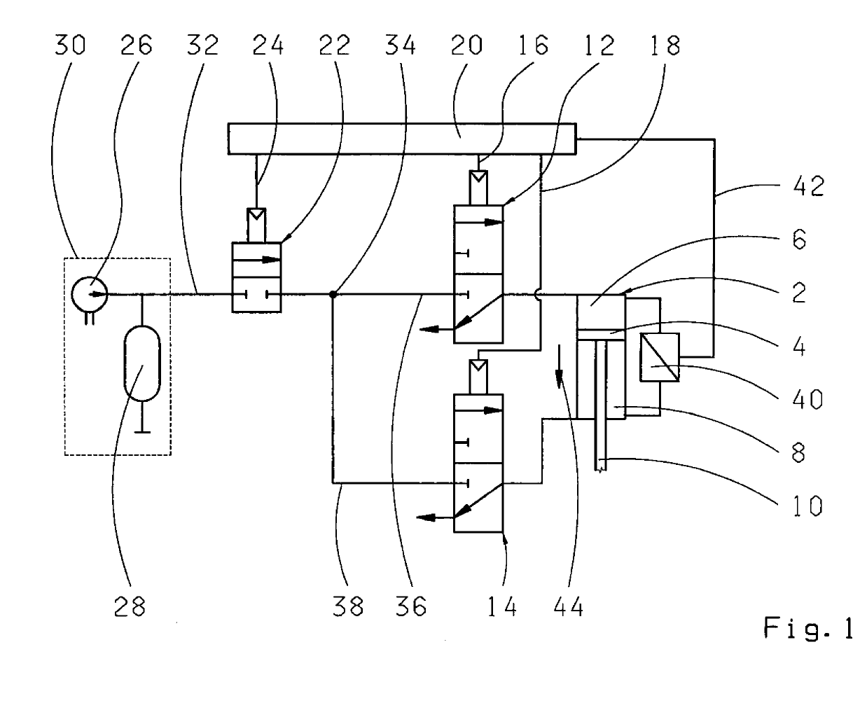

Accordingly, FIG. 1 shows schematically a device for controlling a fluid-actuated, double-action operating cylinder 2 with two cylinder chambers 6 and 8 separated from one another by a control piston 4. The control piston 4 is connected to a piston rod 10 that passes through an end wall of the cylinder chamber 8 and serves to move a component that has to be displaced in a known manner.

The first cylinder chamber 6 is associated with a switching valve 12 made as a 3/2-way electromagnetic valve, which controls the flow of fluid in and out of the cylinder chamber 6 and the cutting off of this cylinder chamber from the inflow or outflow. The second cylinder chamber 8 is associated with a switching valve 14 of the same type. The switching valves 12 and 14 are connected by respective associated control lines 16 and 18 to a control unit 20.

Connected upstream from the two switching valves 12 and 14 is a controllable pressure regulation device 22, which is also connected by a control line 24 to the control unit 20. In the illustrated embodiment, the pressure regulation device is made as a pulse-width modulated, timed pressure regulation valve 22.

The device is supplied with pressure fluid from a pressurized fluid source 30, comprising a fluid pump 26 and a pressure fluid reservoir 28, to which a pressure fluid line 32 is connected. At a branching point 34, the pressurized fluid line 32 branches into two switching valve supply lines 36 and 38 leading, respectively, to the two switching valves 12 and 14.

Between the first cylinder chamber 6 and the second cylinder chamber 8 of the operating cylinder 2 is arranged a differential pressure sensor 40 in flow connection mode, which detects the pressure difference between the two cylinder chambers 6, 8 and transmits to the control unit 20, via a signal line 42, a signal corresponding to the pressure difference.

In FIG. 1, the two switching valves 12 and 14 are shown in positions in which the associated cylinder chambers 6 and 8, respectively, are vented toward the outside. To move the control piston 4 in the direction of an arrow 44, the switching valve 12 connects the first cylinder chamber 6 to the inflow line 36 while the second cylinder chamber 8 remains vented. By way of a differential pressure sensor 40, the pressure difference between the first cylinder chamber 6 and the second cylinder chamber 8, and hence the actual available control force of the operating cylinder 2, is measured. A corresponding pressure difference signal is sent to the control unit 20, which uses this information for actuating the pressure regulation valve 22 which adjusts the working pressure in the first cylinder chamber 6 precisely to the desired valve.

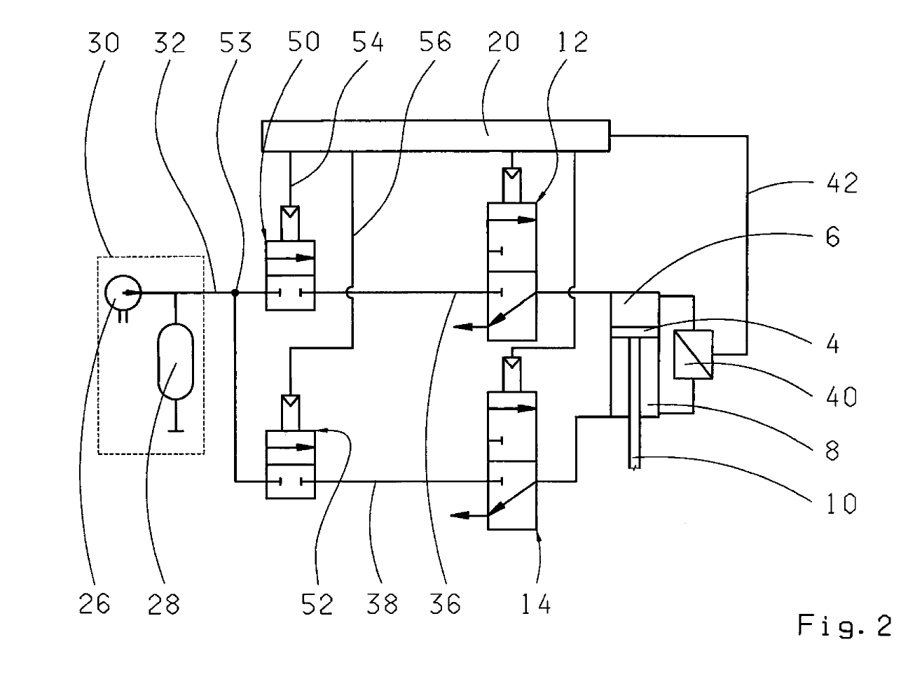

FIG. 2 shows a device which corresponds largely to the device, according to FIG. 1, and to that extent need not be described in detail again. Corresponding components in the two Figures are, in each case, given the same indexes.

In contrast to the device of FIG. 1, the device according to FIG. 2, has two pressure regulation valves 50 and 52, which are arranged downstream from a branching point 53 of the pressure fluid line 32, respectively, in the supply lines 36 and 38 to the two switching valves 12 and 14. Thus, pressure regulation valve 50 is associated with switching valve 12 and pressure regulation valve 52 with switching valve 14. The device, shown in FIG. 2, enables control and regulation processes in which defined pressures have to be produced in each of the two cylinder chambers 6 and 8.

In such a case, the first cylinder chamber 6 is connected to the pressure fluid supply, via its associated switching valve 12, and the second cylinder chamber 8, via its associated switching valve 14, so that the fluid pressure in the cylinder chambers 6 and 8 can be adjusted individually by way of their respectively associated pressure regulation valves 50 and 52. The actual pressure difference between the two cylinder chambers 6, 8 is detected by the differential pressure sensor 40 connected to those cylinder chambers and transmitted via the control line 42 to the control unit 20, which actuates the pressure regulation valves 50 and 52 via the respectively associated control lines 54 and 56.

### REFERENCE NUMERALS

2 operating cylinder
4 control piston
6 cylinder chamber
8 cylinder chamber
10 piston rod
12 switching valve
14 switching valve
16 control line
18 control line
20 control unit
22 pressure regulation valve
24 control line
26 pressure fluid pump
28 pressure fluid reservoir
30 pressure fluid source
32 pressure fluid line
34 branching point
36 switching valve supply line
38 switching valve supply line
40 differential pressure sensor
42 signal line
44 arrow, actuation direction
50 pressure regulation valve
52 pressure regulation valve
53 branching point
54 control line
56 control line

1-4. (canceled)

5. A device for controlling a fluid-actuated, double-action operating cylinder (2) having two cylinder chambers (6, 8) separated from one another by a control piston (4), the device comprises two switching valves (12, 14) each being associated with a respective one of the two cylinder chamber (6, 8) and a differential pressure sensor device (40) for detecting fluid supply pressure, as well as a control unit (20) connected to the two switching valves (12, 14) and to the pressure sensor device (40), the differential pressure sensor (40) being arranged in connection between the two cylinder chambers (6, 8) and detecting an actual pressure difference between the two cylinder chambers (6, 8) and transmits the pressure difference to the control unit (20).

6. The device according to claim 1, wherein a pressure regulation device (22) is connected upstream from the two switching valves (12, 14).

7. A device for controlling a fluid-actuated, double-action operating cylinder (2) having two cylinder chambers (6, 8) separated from one another by a control piston (4), the device comprises two switching valves (12, 14) each being associated with a respective one of the two cylinder chamber (6, 8) and a differential pressure sensor device (40) for detecting fluid supply pressure, as well as a control unit (20) connected to the two switching valves (12, 14) and to the pressure sensor device (40), the differential pressure sensor (40) being arranged in connection between the two cylinder chambers (6, 8) and detecting an actual pressure difference between the two cylinder chambers (6, 8) and transmits the pressure difference to the control unit (20), a pressure fluid line (32) is connected to a pressure fluid source (30) and branches at a branching point (34), which is upstream from the two switching valves (12, 14), into two switching valve supply lines (36, 38), a pressure regulation valve (22) is arranged upstream from the branching point (34) and is actuated by the control unit (20).

8. The device according to claim 7, further comprising two pressure regulation valves (50, 52) each of which is respectively arranged in one of the two switching valve supply lines (36, 38) and actuated by the control unit (20).

9. A device for controlling a fluid-actuated, double-action operating cylinder (2), having a first cylinder chamber (6) and a second cylinder chamber (6, 8) that are separated by a control piston (4), the device comprises:
a first switching valve (12) communicating, via a first supply line (34), with the first cylinder chamber (6) and a pressure regulation device (22) and, via a first control line (16), with a control unit (20);
a second switching valve (14) communicating, via a second supply line (38), with the second cylinder chamber (8) and the pressure regulation device (22) and, via a second control line (18), with the control unit (20);
each of the first cylinder chamber (6) and the second cylinder chamber (8) communicating with a differential pressure sensor device (40) which senses a pressure of each of the first cylinder chamber (6) and the second cylinder chamber (8) and determines a pressure differential between the pressure of the first cylinder chamber (6) and the pressure of the second cylinder chamber (8), the differential pressure sensor device (40) transmitting the pressure differential, via a signal line (42), to the control unit (20);
the control unit (20) adjusting each of the first switching valve (12), the second switching valve (14) and the pressure regulation device (22) depending on the pressure differential to control pressures of each of the first cylinder chamber (6) and the second cylinder chamber (8); and
the first supply line (34) and the second supply line (38) unite with each other at a branching point (34) to form a pressure fluid supply line (32), which connects to a pressurized fluid source (30), the pressure regulation device (22) is located along the pressure fluid supply line (32) between the pressurized fluid source (30) and the branching point (34).
